(19) United States
(12) Patent Application Publication
(10) Pub. No.: US 2007/0192365 A1
(43) Pub. Date: Aug. 16, 2007

(54) Common inventory interface for order entry and payment systems

(75) Inventors: Jia Lin Li, Beijing (CN); Lev Mirlas, Thornhill (CA); Zhong Hua Wu, Beijing (CN); Xia Zhang, Beijing (CN); Yanchun Zhao, Toronto (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/342,768

(22) Filed: Jan. 30, 2006

(51) Int. Cl. G06F 17/00

(52) U.S. Cl. 707/104.1

(57) ABSTRACT

Embodiments of the present invention address deficiencies of the art in respect to accessing an inventory management system and provide a method, system and computer program product for allocating inventory using a common inventory interface for ordering and payment systems. In one embodiment of the invention, an e-commerce data processing system can include an order entry component configured for coupling to an inventory management system irrespective of an underlying inventory allocation strategy for the inventory management system. The system further can include an inventory management system implementing an underlying inventory allocation strategy and realizing a common inventory interface exposing a check inventory method operable to report an available state for an inventory item irrespective of an underlying strategy for the inventory management system. Finally, the system yet further can include a payment capture component configured for coupling to the order entry component.

### BACKGROUND OF THE INVENTION

1. Field of the Invention

The present invention relates to the field of e-commerce systems and more particularly to the field of inventory management in an e-commerce system.

2. Description of the Related Art

E-commerce systems have evolved to provide virtual storefronts whose operational capabilities far exceed those of the traditional, brick and mortar store. Whereas in the brick and mortar store, each of the sales, marketing, order fulfillment, inventory, and customer service functions remain the separate responsibilities of corresponding business roles, in a well-defined e-commerce system, each of the sales, marketing, order fulfillment, inventory and customer service can be integrated in a single computing system in a highly automated fashion. Consequently, a more optimal business operation can result in which data flows between different functional subsystems seamlessly to facilitate the daily conduct of business managed by the e-commerce system.

In the prototypical e-commerce system, an on-line catalog of available goods and/or services for sale can be established along with associated pricing. Customers can be provided with a store front user interface through which customers can browse the on-line catalog. When a customer desires to purchase a product or service, the customer can so indicate causing the addition of the selected product or service to an on-line shopping cart, though it is also known to bypass the shopping cart model in favor of direct purchase model.

Inventory management supports order capture, payment and catalog management in an e-commerce system. Inventory management refers to the accounting and management of product inventory on-hand and available for allocation to a customer. As such, inventory management can be a critical aspect of order capture in that inventory must be available for shipment to customers. Likewise, inventory management can be a critical aspect of payment processing as payment can be processed for a purchase only when inventory is allocated to a customer.

In many e-commerce systems, each of the order entry, catalog navigation and payment processing sub-systems are preferred to be separate in nature. In some systems, each different sub-system can be developed separately by different developers in different firms. Furthermore, each separate sub-system can execute independently of the other. In consequence, maintaining access to a common inventory management system can require a high degree of coordination among the sub-systems of the e-commerce system. Where the coordination falls short, incompatibilities can arise between the different sub-systems and the inventory management system.

Inventory management systems, in of themselves, vary in functionality and strategy. For instance, in an “available to promise” (ATP) based inventory system, inventory reporting can include not only inventory on hand, but also inventory expected to be on hand. In this regard, inventory on hand can be classified as allocated or non-allocated, whereas anticipated inventory which has been allocated can be classified as backordered. By comparison, in a non-ATP based inventory system, only inventory on hand can be reported to coupled components of an e-commerce system so as to guarantee inventory for orders on a first come, first served basis.

In as much as inventory systems can vary in strategy, other components of an e-commerce system, including order entry and payment capture can be hard coded to account for the particular strategy of the inventory system. Yet, to force hard coding in the components of the e-commerce system can inhibit the extensibility and replaceability of the components. Moreover, to force hard coding in the components of the e-commerce system can inhibit the extensibility and replaceability of the inventory management system itself.

### BRIEF SUMMARY OF THE INVENTION

Embodiments of the present invention address deficiencies of the art in respect to accessing an inventory management system and provide a novel and non-obvious method, system and apparatus for a common inventory interface for ordering and payment systems. In one embodiment of the invention, an e-commerce data processing system can include an order entry component configured for coupling to an inventory management system irrespective of an underlying inventory allocation strategy for the inventory management system. In this regard, in one aspect of the invention, the inventory strategy can be a strategy selected from the group consisting of an ATP-based strategy and a non-ATP based strategy.

The system further can include an inventory management system implementing an underlying inventory allocation strategy and realizing a common inventory interface exposing a check inventory method operable to report an available state for an inventory item irrespective of an underlying strategy for the inventory management system. For instance, the available state can be disposed in a checked state data structure for an inventory item including each of an allocated state, a non-allocated state, a backordered state, and an available state.

Finally, the system yet further can include a payment capture component configured for coupling to the order entry component. The payment capture component can include program code enabled to calculate payment for an order item based upon the available state irrespective of an underlying strategy for the inventory management system.

In another embodiment of the invention, an inventory allocation method can include invoking a check inventory method in an inventory management system realization of a common inventory interface responsive to submitting an order item for ordering. The method further can include receiving an inventory state for the order item and allocating an inventory item for the order item irrespective of an underlying inventory strategy for the inventory management system. The method yet further can include calculating payment authorization for the order item utilizing the inventory state irrespective of an underlying inventory strategy for the inventory management system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an e-commerce data processing system configured with a common inventory interface for ordering and payment systems;

FIG. 2 is a class diagram of the e-commerce data processing system of FIG. 1;

FIG. 3 is a state diagram of the common inventory interface of FIG. 1;

FIG. 4 is a component interaction diagram illustrating an order entry process utilizing the common inventory interface of FIG. 1.

### DETAILED DESCRIPTION OF THE INVENTION

Embodiments of the present invention provide a method, system and computer program product for a common inventory interface for ordering and payment systems. In accordance with an embodiment of the present invention, a common inventory interface can be provided which can include a check inventory method and an allocate inventory method. The check inventory method can be accessed by external e-commerce system components, including order entry and payment capture, and can check inventory availability for order items before order submission and payment authorization. The allocate inventory method, by comparison, can allocate inventory on command if the inventory has not been allocated after order submission and payment authorization.

The check inventory method and the allocate inventory method can manage a checked state for inventory which checked state can be accessed by other components of the e-commerce system, including order entry and payment capture. The checked state can include “not allocated” (NALC), “allocated” (ALLC), “available” (AVL) and “backordered” (BO). Utilizing the checked state, order entry and payment capture can compute appropriate payment authorization and shipping charges, irrespective of the nature of the inventory management system. More specifically, if the inventory management system is ATP, inventory having an ALLC and AVL state can be utilized in the payment computation, wherein if the inventory management is non-ATP, inventory having only an ALLC state is considered.

In operation, whenever an order item is to be updated, for instance in response to the addition, deletion and change of an order item, the check inventory method can be called to determine inventory availabilities for a proposed order for a customer. Once an order has been requested, the check inventory method again can be called to check the availability of the requested order items in the order, or to obtain an ATP estimate for the order items. Utilizing the inventory availability provided by the check inventory method, shipping charges can be computed. Finally, when submitting an order, the check inventory method once again can be called to determine payment authorization in the payment capture system.

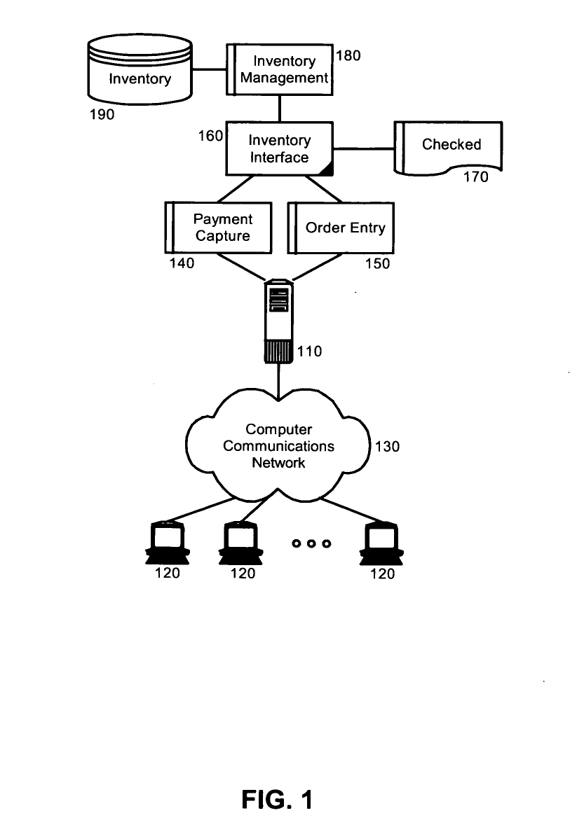

In further illustration, FIG. 1 is a schematic illustration of an e-commerce data processing system configured with a common inventory interface for ordering and payment systems. The e-commerce data processing system can include a host computing platform 110 configured for coupling to one or more client computing devices 120 over a computer communications network 130. Notably, though only a single computing device is shown as the host computing platform 110, the host computing platform 110 can include one or more multiple computing platforms acting in concert to support the operation of an e-commerce system.

The host computing platform 110 can support the execution of at least a payment capture component 140 and an order entry component 150. The order entry component 150 can process the request and submission of an order of one or more items in inventory 190 by one or more customers accessing the e-commerce system through client computing devices 120. Likewise, the payment capture component 140 can process payment authorization for orders processed in the order entry component 150. Notably, each of the payment capture component 140 and order entry component 150 can be communicatively coupled to a common inventory interface 160 to inventory management system 180. In this regard, the inventory management system 180 can implement an inventory management strategy such as ATP or non-ATP.

The common inventory interface 160 can expose a checked data structure 170 for inventory items in inventory 190, through a check inventory method and an allocate inventory method. The check inventory method can be called by the order entry component 150 in order to verify inventory levels for an order item, irrespective of the underlying strategy of the inventory management system 180. Instead, the check inventory method can manage the checked data structure 170 according to the underlying strategy of the inventory management system 180. Consequently, neither the order entry component 150 nor the payment capture component 140 need be hard coded to account for the strategy of the inventory management system 180. Furthermore, different strategies for the inventory management system 180 can be applied seamlessly without affecting the operation of the payment capture component 140 and the order entry component 150.

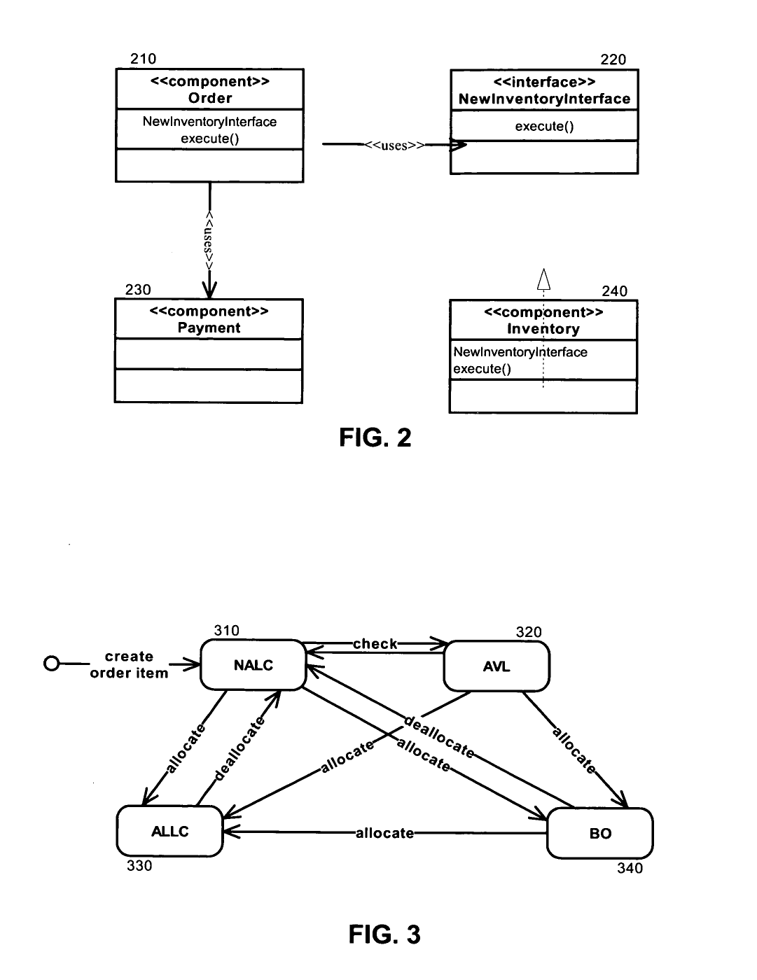

The separability of the inventory management system 180 from the order entry component 150 and the payment capture component 140 will be apparent from a review of the class diagram of FIG. 2. As shown in FIG. 2, an order component 210 can use each of a payment component 230 and an inventory component 240 that realizes an inventory interface 220. The inventory interface 220 can specify a check inventory method and an allocate inventory method. In this way, so long as the inventory component 240 realizes the inventory interface 220, irrespective of the strategy of the inventory component 240, the order component 210 can use the inventory component 240 without requiring specific code for the inventory component 240.

Referring now to FIG. 3, a state diagram is shown of the checked data structure of the common inventory interface of FIG. 1. The checked data structure for an inventory item for an inventory management system—regardless of the strategy implemented by the inventory management system—can vary from a NALC state 310 to an ALLC 330 state depending upon whether the inventory item has been allocated. Also, to the extent that a corresponding inventory management system implements an ATP strategy, a BO state 340 can be provided for anticipated and pre-allocated inventory items. In either case, however, an AVL state 320 can account for allocated inventory items in the case of either an ATP or non-ATP based inventory management system, and back-ordered inventory items in the case of an ATP based inventory management system.

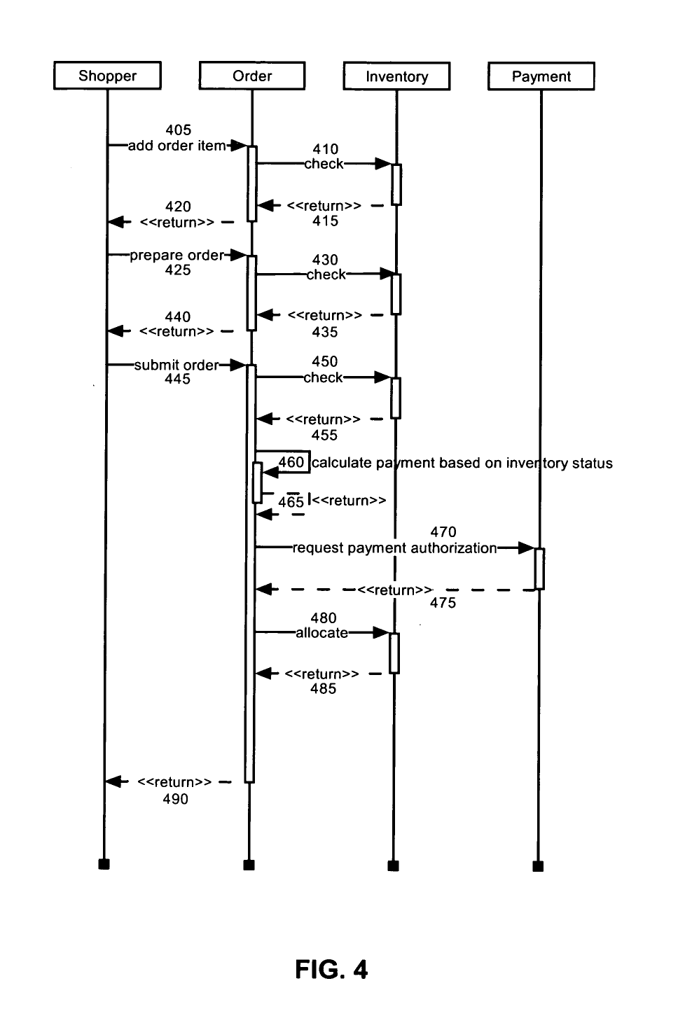

In operation, an order entry component of the e-commerce system can call operations in the inventory managements system through the common inventory interface without regard to the strategy of the inventory management system. In illustration, FIG. 4 is a component interaction diagram illustrating an order entry process utilizing the common inventory interface of FIG. 1. Initially, in step 405 a shopper can add an order item in an order component. In step 410, the order component can call a check inventory method in the inventory management system. In step 415, the inventory management system can return currently available inventory for the order item and in step 420 this information may be returned to the shopper. Importantly, the currently available inventory can account for either merely allocated inventory, or both allocated and backordered inventory depending upon the strategy of the inventory management system.

In step 425, an order can be prepared by the shopper for the order component and, once again, in step 430 the order component can call a check inventory method in the inventory management system. Correspondingly, in step 435, the inventory management system can return currently available inventory for the order item and in step 440 this information may be returned to the shopper. Subsequently, in step 445, the shopper can submit the order to the order component. As before, in step 450 the order component can call a check inventory method in the inventory management system, and in step 455, the inventory management system can return currently available inventory for the order item.

In step 460, the order component can calculate payment information based upon the inventory status returned in step 455. In this regard, the payment information can be computed irrespective of whether the inventory management system is ATP based or non-ATP based, for example. Rather, the payment information can be computed only in respect to the data returned by the inventory management system. Subsequently, in step 465, the payment calculation can be returned to the order entry component and in step 470, payment authorization can be requested of the payment capture component. Thereafter, in step 475 the result of the payment authorization request can be provided to the order entry component. In step 480, inventory can be allocated based upon the submitted order of step 445, and in step 485, the result of the allocation can be provided to the order entry component. Finally, in block 490, the result of the submit order operation can be provided to the shopper.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system for allocating inventory, the data processing system comprising:
an inventory management system implementing an underlying inventory allocation strategy and realizing a common inventory interface exposing a check inventory method operable to report an available state for an inventory item irrespective of an underlying strategy for the inventory management system; and,
an order entry component configured for coupling to the inventory management system irrespective of an underlying inventory allocation strategy for the inventory management system.

2. The system of claim 1, further comprising a payment capture component configured for coupling to the order entry component.

3. The system of claim 1, wherein the inventory strategy is a strategy selected from the group consisting of an available to promise (ATP) based strategy and a non-ATP based strategy.

4. The system of claim 1, wherein the available state, for an inventory item, is disposed in a checked state data structure the available state comprising one of an allocated state, a non-allocated state, a backordered state, and an available state.

5. The system of claim 2, where the payment capture component comprises program code enabled to calculate payment for an order item based upon the available state irrespective of an underlying strategy for the inventory management system.

6. An data processing system implemented inventory allocation method responsive to submitting an order item for ordering, the method comprising:
, invoking a check inventory method for the order item in an inventory management system realization of a common inventory interface;
receiving an inventory state for the order item from the check inventory method; and,
allocating an inventory item for the order item irrespective of an underlying inventory strategy for the inventory management system.

7. The method of claim 6, further comprising calculating payment authorization for the order item utilizing the inventory state irrespective of an underlying inventory strategy for the inventory management system.

8. The method of claim 6, wherein receiving an inventory state for the order item comprises, receiving an inventory state for the order item accounting for one of an allocated state and a backordered state together, and an allocated state alone.

9. The method of claim 6, wherein allocating an inventory item for the order item irrespective of an underlying inventory strategy for the inventory management system, comprises allocating an inventory item for the order item irrespective of whether the underlying inventory strategy for the inventory management system is one of an available to promise (ATP) based strategy, and a non-ATP based strategy.

10. A computer program product comprising a computer usable medium embodying computer usable program code for inventory allocation, the computer program product comprising:
computer usable program code for invoking a check inventory method in an inventory management system realization of a common inventory interface responsive to submitting an order item for ordering;
computer usable program code for receiving an inventory state for the order item; and,
computer usable program code for allocating an inventory item for the order item irrespective of an underlying inventory strategy for the inventory management system.

11. The computer program product of claim 10, further comprising computer usable program code for calculating payment authorization for the order item utilizing the inventory state irrespective of an underlying inventory strategy for the inventory management system.

12. The computer program product of claim 10, wherein the computer usable program code for receiving an inventory state for the order item comprises, computer usable program code for receiving an inventory state for the order item accounting for one of an allocated state and a backordered state together, and an allocated state alone.

13. The computer program product of claim 10, wherein the computer usable program code for allocating an inventory item for the order item irrespective of an underlying inventory strategy for the inventory management system, comprises computer usable program code for allocating an inventory item for the order item irrespective of whether the underlying inventory strategy for the inventory management system is one of an available to promise (ATP) based strategy, and a non-ATP based strategy.
